(19) United States
(12) Patent Application Publication
(10) Pub. No.: US 2016/0027071 A1
(43) Pub. Date: Jan. 28, 2016

(54) Method and System for Contractually Permitting a Vehicle Owner to Recover Diminished Value of Damaged Vehicle

(71) Applicant: Jon Krutchik, Southwest Ranches, FL (US)

(72) Inventor: Jon Krutchik, Southwest Ranches, FL (US)

(21) Appl. No.: 14/808,606

(22) Filed: Jul. 24, 2015

Related U.S. Application Data
(60) Provisional application No. 62/029,778, filed on Jul. 28, 2014.

(51) Int. Cl. G06Q 30/02

(52) U.S. Cl. CPC G06Q 30/0278

(57) ABSTRACT

Computer-processed method for recovery of diminished value processes repair estimate-$R, offer to buy damaged vehicle-$A and max-min coverage. Pay-out computed with lowest present index-$I value for vehicle. NO reported accident, first payment offer processed: (a) if $A greater than $1, offer $0; and (b) if $A less than $I, offer $A plus $Min. YES reported accident, second payment offer processed: (c) if $R less than $Max and $R less than $I minus $A, then offer $R; (d) if $R less than $Max and $R greater than $I minus $A, then offer $I minus $A but no more than $Max; (e) if $R greater than $Max and $Max less than $I minus $A, then offer $Max; and (f) if $R greater than $Max, and $Max greater than $I minus $A, then offer $I minus $A. Close contract by effecting payment to owner if owner transfers vehicle.

This is a regular patent application based upon and claiming the benefit of provisional patent application Ser. No. 62/029,778 filed Jul. 28, 2014, the contents thereof is incorporated herein by reference thereto.

The present invention relates to a computer assisted method and a related system for providing an options contract for a vehicle owner to recover diminished value of the owner's vehicle subject to accidental damage.

### BACKGROUND OF THE INVENTION

It is well known when an owner purchases a vehicle, such as an automobile, or leases a vehicle, as soon as the vehicle is owned or leased and in the possession of the owner, the vehicle's value decreases due to immediate depreciation. As used herein, the term “owner” refers to the owner who purchased the vehicle or the lessee who leased the vehicle. Examples of typical depreciation follow in the Depreciation Table.

Depreciation Table (Example)

1^{st} Year of vehicle (car) ownership 20% purchase price
2^{nd} year - 15% from depreciated 1^{st} year value
3^{rd} year - 15% from depreciated 2^{nd} year value

Additionally, owners typically cannot obtain insurance coverage which will pay for the fair market value of an automobile if a claim is made on typical automobile insurance policies. Many automobile insurance policies explicitly state that the policy does not cover the depreciation or the diminished value of an automobile which has sustained damage in an accident. As used herein, the term “vehicle” refers to an automobile or passenger truck or other vehicle which can be typically purchased or leased. It has been reported in the popular press that vehicles subject to accidental damage depreciate as much as 25% from the then current depreciated value of the vehicle.

Accordingly, there is a need to provide for a contract which provides a benefit to the vehicle owner to recover the diminished value of the owner's vehicle subject to accidental damage.

### OBJECTS OF THE INVENTION

It is an object of the present invention to provide a computer assisted method for providing an options contract for a vehicle owner to recover the diminished value of the owner's vehicle subject to accidental damage.

It is an additional object of the present invention to provide a monetary benefit payment to the vehicle owner which compensates the owner for diminished value.

It is a further object of the present invention to utilize a bona fide offer from a third-party buyer (who seeks to purchase the damaged vehicle) and an index value from reliable database sources who publish values of used vehicles subject to hierarchical vehicle condition classifications.

It is another object of the present invention to provide a contractual benefit to the vehicle owner based upon minimum and maximum contractual coverages in order to provide a benefit payment to the vehicle owner to cover the diminished or the depreciated value of the vehicle.

It is a further object of the present invention to provide a computer assisted method for contractually permitting the vehicle owner to recover diminished value of the owners vehicle subject to accidental damage.

### SUMMARY OF THE INVENTION

The process is a computer assisted method for contractually permitting a vehicle owner to recover diminished value of the owner's vehicle subject to accidental damage from a second contracting party. The process is deployed over a computer system connected to the internet. After the accidental damage, the system obtains an estimate to repair the damaged vehicle. The contractual process requires that the owner (a) sell the vehicle to the Sys Oper (system operator) or a designated party selected by the Sys Oper (typically a car dealer who provides an actual cash value estimate to the owner). The system and process obtains a bonafide offer to buy the damaged vehicle from a third party buyer (typically, a car dealer). The system, via an input process, determines whether the owner reported the accidental damage event (YES—report-code event; NO no-report-code event). The system obtains a present index value for the damaged vehicle from one or more database sources which publish values of used vehicles and selects as the index value, the lowest index value for the damaged vehicle from a group of hierarchical vehicle condition classifications. This index value for the damaged vehicle is called sometimes called $index. The system, via an input obtains the estimate to repair the damaged vehicle which is called $repair or $R. The system obtains the bonafide offer to buy the damaged vehicle as $ACO or ACO. Prior to the accident, the owner has selected, and the system has a data stop, for a maximum contractual coverage as $max-coverage or $Max. Typically, a minimum $Min is also used as $min-coverage. If NO reported accident, then a first payment offer is calculate for a no-report-coded accident event as either: (a) if $ACO is greater than $index, then offer $0; and (b) if $ACO is less than $index, then offer $ACO plus $min-coverage.

If YES reported accident, then a second payment offer is calculated for a report-coded accident event, as one of: (a) if $repair is less than $max-coverage, and $repair is less than $index minus $ACO, then offer $repair; (b) if $repair is less than $max-coverage, and $repair is greater than $index minus $ACO, then offer$index minus $ACO but no more than the $max-coverage; (c) if $repair is greater than $max-coverage, and $max-coverage is less than $index minus $ACO, then offer $max-coverage; and (d) if $repair is greater than $max-coverage, and $max-coverage is greater than $index minus $ACO, then offer$index minus $ACO.

The contract with the owner closes by effecting payment to the owner as the calculated processed payment offer when the owner transfers ownership of the damaged vehicle to the second contracting party or to the Sys Oper. Alternatively, the Sys Oper can transfer the “right to the title and vehicle ownership” to the car dealer who issued the ACO. In that event, the Sys Oper pays the owner the calculated coverage payment. Otherwise, the Sys Oper takes possession of the vehicle and pays the owner the $ACO plus the calculated coverage payment.

The index value for the damaged vehicle may be obtained from one or more sources which estimate the value of used vehicles, from the group of indexes including the Black Book™, Kelly's Blue Book™ and the NADA Guide™ for used cars. the system selects either (a) the lowest index value for the damaged vehicle from vehicle classifications including extra clean, clean, average or rough, or (b) a composite average of two or more indexes including the Black Book™, Kelly's Blue Book™ and the NADA Guide™ for used cars. The system selects the lowest index value for the damaged vehicle from vehicle classifications including extra clean, clean, average or rough.

### BRIEF DESCRIPTION OF THE DRAWINGS

Further objects and advantages of the present invention are described in the specification and the claims in the drawings which illustrate:

FIGS. 1A, 1B, 1C and 1D diagrammatically illustrate, in flowchart form, the purchase option or contractual method to recover diminished value of a vehicle in accordance with the principles of the present invention.

FIG. 2 diagrammatically illustrates a distributed computer system which carries out the method as a system.

### DETAILED DESCRIPTION OF THE PREFERRED EMBODIMENT

The present invention relates to a computer assisted method and a system for providing an options contract or a contractual arrangement permitting the vehicle owner to recover the diminished value of the owner's vehicle subject to accidental damage. Effectively, the vehicle owner or lessee enters into a contract with a second party which provides a monetary benefit to the owner in the event of accidental damage to his or her vehicle. Specific abbreviations and some definitions are set forth towards the end of this specification. Other definitions are discussed herein. Reference is sometimes made in this patent specification to “index” which is defined as “a statistical value that represents the price or value of an aggregate of goods, services, wages or other measurable quantities in comparison with a reference number for a previous period of time.” See The Free Dictionary by FarLex™. In particular, the index is referred to herein includes the Black Book™ index for used vehicles, Kelly's Blue Book™ and the NADA Guide™ for used cars. These indexes provide guides for establishing a value of a vehicle.

Further, these indexes provide a hierarchical vehicle condition classifications which permit the user of the indices to establish a value for a particular vehicle. Typical classifications include extra clean, clean, average or rough. Other words or symbols may be utilized to classify vehicles.

As stated earlier, a vehicle insurance company can exclude first party diminished value claims in the insurance contract. Further, when the vehicle owner is in an accident and the party at fault has nominal or minimal insurance coverage, the party and the party at fault has no assets needed to pay for excessive damage to the owner of the vehicle, the owner of the vehicle loses the value of the auto due to non-coverage. The present invention provides a financial back stop to this loss.

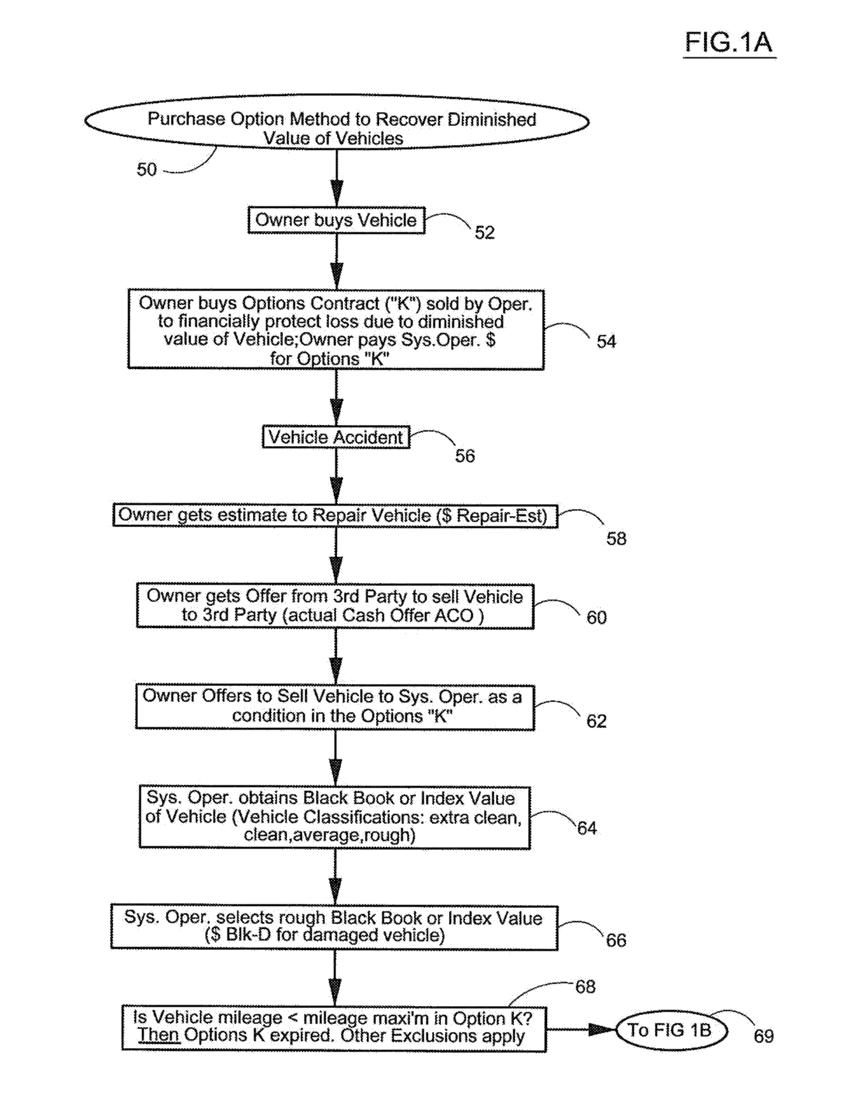

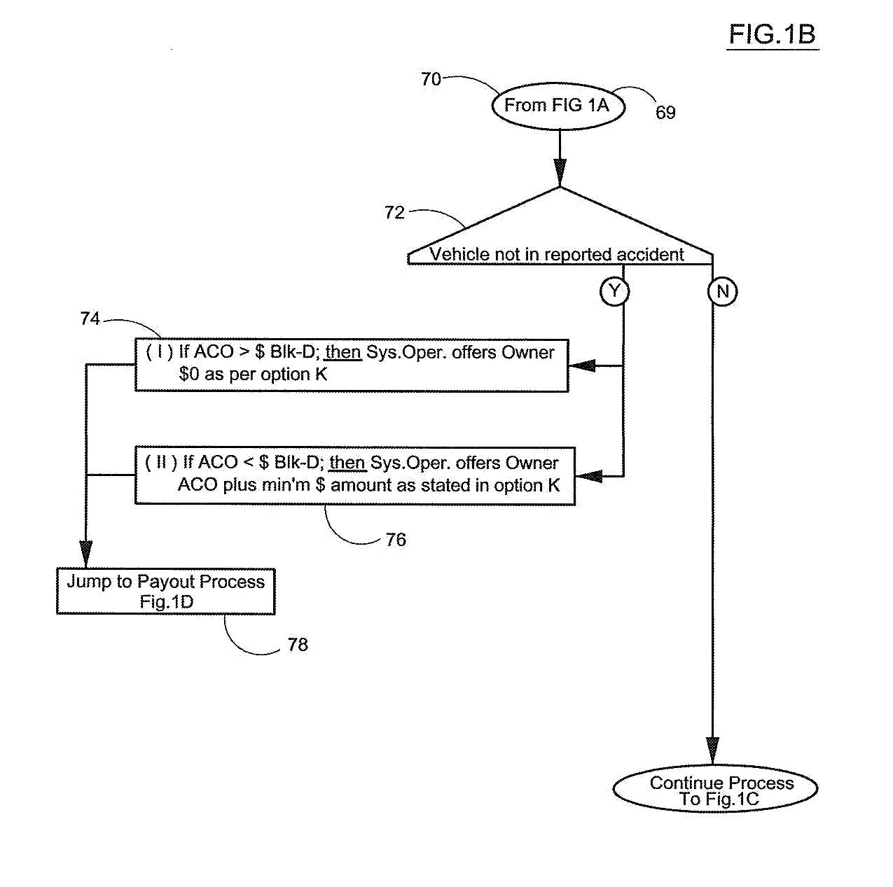

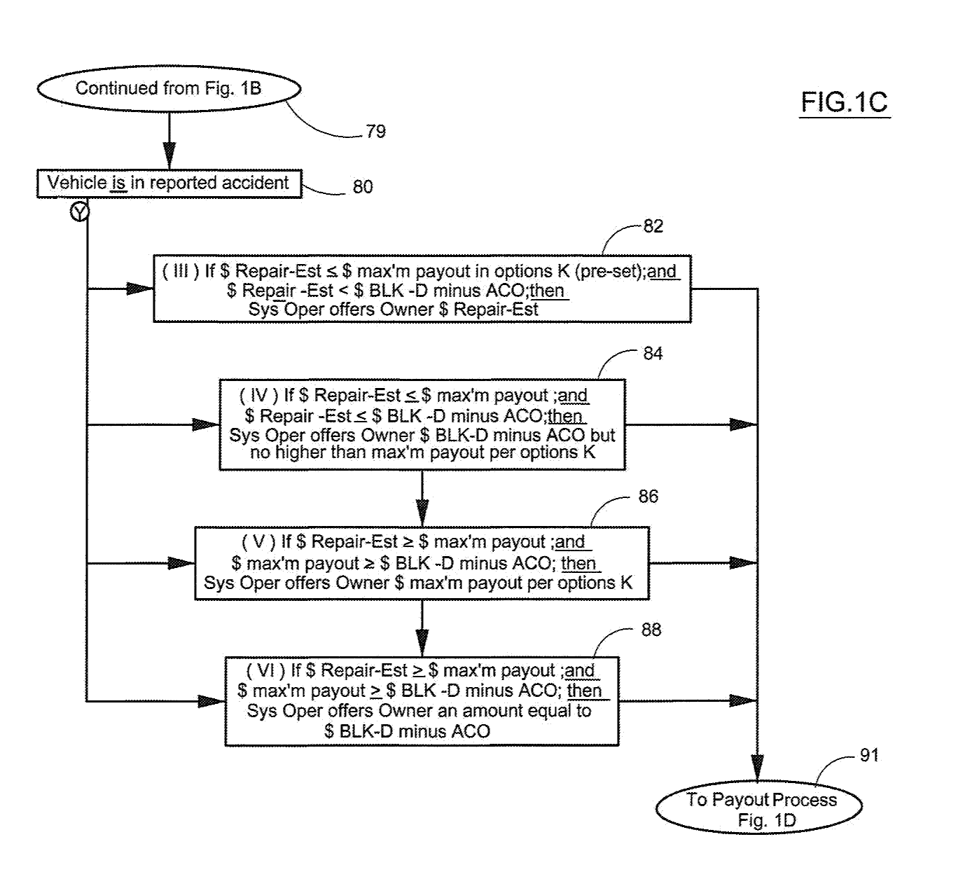

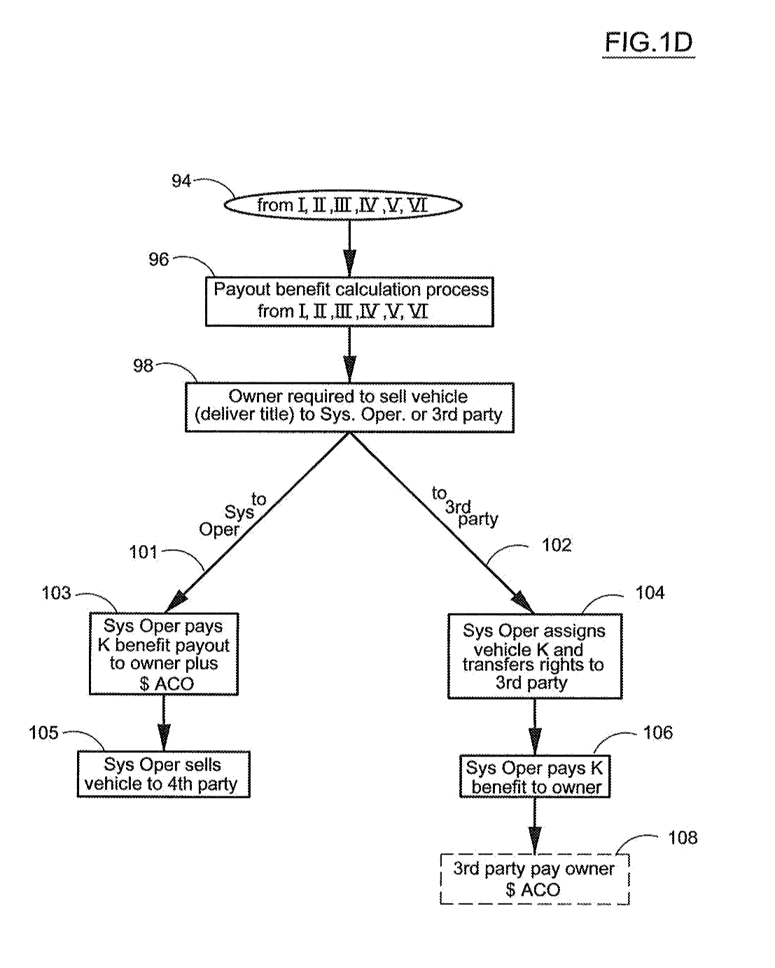

FIGS. 1A, 1B, 1C and 1D are discussed concurrently herein. These Figures diagrammatically illustrate a flowchart or the steps associated with a purchase of an options method to recover diminished value of a vehicle, see step 50. In step 52, the owner buys or leases a vehicle. In step 54, the owner buys an options contract K sold by the system operator (Sys Oper)to financially protect against loss due to diminished value of a vehicle if the vehicle experiences accidental damage. The owner pays the system operator a certain amount of money for this options contract or for this contractual benefit to a second contracting party.

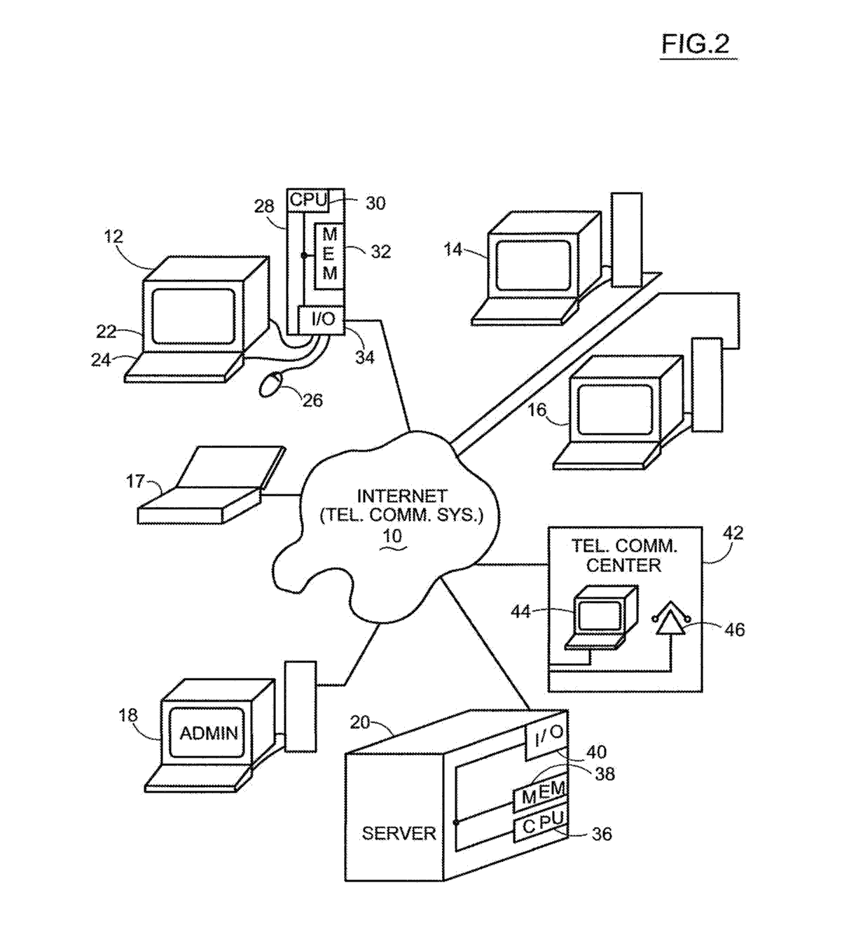

The owner's vehicle is subject to an accident in step 56. In step 58, the owner gets an estimate to repair the vehicle $R. Ultimately the owner must repair the vehicle. Typically, the owner's primary vehicle insurance will pay for such repairs, not including the deductible, if any. In step 60, the owner gets an offer from a third-party to sell the vehicle to the third-party. In this method and system, this is an actual cash offer ACO ($ACO) made to the owner or lessee. Typically, this third-party is a car dealer. In step 62, the owner offers to sell the vehicle to the system operator as a condition in the options or benefit contract. In step 64, the system operator's computer system (described later in connection with FIG. 2) obtains the index value for the damaged vehicle, such as the index value from the Black Book™ ($Blk-D) or Kelly's Bluebook™ or the NADA Guide™.

Additionally the system operator's computer system obtains the index value either (a) directly from one of these database sources, which publish values of used vehicles, or (b) obtains several index values from these sources for the damaged vehicle (now repaired) and averages the indexes from two or more of the index providers. Additionally, these database sources which publish values of used vehicles provide hierarchical vehicle classifications such as extra clean, clean, average or rough or similar vehicle condition grading classifications. In step 66, the system operator computer selects the rough or the lowest vehicle condition classification from the index provider (Black Book index) $B ($Blk-D).

In step 68, the system operator computer system determines whether the owners vehicle mileage is less than the maximum mileage (Max Mileage) provided in the options contract. This data is a manual input. If so, the options contract or contractual benefit with the second party has contractually expired or has been terminated. Other exclusions may be provided in the contract for such as detection of alteration of the vehicle's odometer (TMU), excessive wear and tear such as large dents or a poor paint on the vehicle, or mismatched tires or bald tires on the vehicle. There are other exclusionary events and conditions that may void or cause expiration or termination of the contract. Step 69 jumps the program to FIG. 1B.

Sometimes the owner of the vehicle does not report the accident to his or her insurance company but rather repairs the damaged vehicle without making a report. Step 72 recognizes that the damaged vehicle has not been reported as an accident. In this situation, the computer system loads an events report input (manual) and assigns a no-report-code to the event and the processed data. Step 74 (I) indicates that the Sys Oper computer system determines if the actual cash value ACO is greater than the index value $B, then the system operator via the computer system offers the owner $0 or nothing in accordance with the options contract. If the conditions of step 74 are not met, in step 76 (II), if the actual cash value is less than the index value $B, then the system operator computer offers the vehicle owner a payout equivalent to the actual cash offer ACO plus the minimum amount $Min'm as stated in the options contract. In other words, the options contract or the contractual arrangement with the second party has minimum coverage values $Min and maximum coverage values $Max. No payouts from the system exceed maximum coverage value. In this instance in step 76, the vehicle owner is paid the actual cash value ACO plus the minimum amount $Min as indicated the options contract. Step 78 indicates that the process jumps to FIG. 1D. From step 72, if the vehicle has been reported in the accident, the NO branch is taken which leads to the process in FIG. 1C.

In FIG. 1C, jump step 79 indicates that the process continues from FIG. 1B. Step 80 indicates the vehicle has been in a reported accident and, in that situation, the computer program operated by the system operator assigns a report-code to the event and the process. The YES branch is taken from step 80 and, dependent upon whether the conditions are met in steps 82, 84, 86 and 88, depends upon the payout amount or benefit to the vehicle owner.

In step 82 (III), if the repair cost $R is less than or equal to the maximum payout $Max in the options contract, and the $R is less than or equal to the index value $B minus the actual cash value ACO, then the system operator computer program offers the owner the cost to repair $R. Although, in the illustrated embodiment, terms such as “less than or equal to” can also refer to a condition “less than”. Similarly, reference to “greater than or equal to” can refer to “greater than” conditions.

In step 84 (IV), if the repair estimate $R is less than or equal to the maximum payout $Max, and the repair estimate $R is greater than or equal to the index $B minus the actual cash value ACO, then the system operator computer offers the owner the index value $B minus the actual cash offer ACO but the computer system limits the offer to the owner at a value not higher than the maximum payout $Max specified in the options or benefit contract.

In step 86 (V), if the repair estimate $R is greater than or equal to the maximum payout $Max, and the maximum payout $Max is less than or equal to the index value $B minus the actual cash offer ACO, then the system operator computer offers the benefit to the owner of the maximum payout $Max in accordance with the option or benefit contract.

In step eight 88 (VI), if the repair estimate $R is greater than or equal to the maximum payout $Max and the maximum payout $Max is greater than or equal to the index value $B minus the actual cash offer ACO, then the system operator computer generates a a payout offer to the owner in the amount equal to the index value $B minus the actual cash offer ACO. The system then progresses to the payout process in step 91 to FIG. 1D.

FIG. 1D illustrates a payout process for both the accident and no accident conditions. Step 94 indicates that the payment process is fed from calculations I, II, III, IV, V, and VI. Step 96 establishes a payout benefit calculation process from conditions I, II, III, IV, V, and VI.

In step 98, the owner is required to sell the vehicle or deliver title to the system operator or a third-party. If the system operator will be receiving the damaged vehicle (which has been repaired), the branch 101 is taken and, in step 103, the system operator pays the contract benefit payout to the owner plus the actual cash offer $ACO. The $ACO is a realistic valuation of the repaired vehicle. As stated earlier, the owner has to transfer title and possession to the system operator or the third party in accordance with the contract. In step 105, the system operator sells the vehicle to a fourth party.

Returning to step 98, if the vehicle is sold to the third-party, branch 102 is taken. In step 104, the system operator assigns the vehicle contract “transfer right” for the vehicle to the third-party. In other words, the system operator assigns possession and title of the vehicle to the third-party. In step 106, the system operator pays the contract benefit to the owner. In step 108, which is outside the system operators ability to control, the third party pays the vehicle owner the actual cash value $ACO.

In the event the owner has financed the vehicle or the vehicle is subject to a lease (the owner only has a possessory interest, not true ownership interest), an accommodation to the financial company must be made by the owner and by the Sys Oper. In other words, the money benefit for the options or second party contract is not paid to the owner but is ultimately paid to the finance company. The finance company must releases the lien on the vehicle prior to the resale of the vehicle by the Sys Oper (step 105) or the resale by the 3^{rd} party (Step 108).

Specific Abbreviations and Definitions Table

| | |
|---|---|
| K | options contract or owner - second party contract |
| $repair | estimate to repair damaged vehicle |
| $repair - est | See $repair |
| $R | See $repair |
| $ACO | bonafide offer to buy the damaged vehicle |
| ACO | See $ACO |
| event-report | information as to whether the owner reported the |
| | accidental damage event |
| no-report-code | event-report information - NO owner reported damage |
| report-code | event-report information - YES owner reported damage |
| $index | index value for the damaged vehicle from a reliable |
| | source |
| $Blk-D | See $ index |
| $B | See $ index |
| $max-coverage | maximum coverage to reimburse vehicle owner |
| max'm payout | See $max-coverage |
| $Max | See $max - coverage |
| $min-coverage | a minimum coverage to reimburse vehicle owner |
| $Min | See $min-coverage |
| min'm payout | $min-coverage |
| present index | value of damaged vehicle from one or more database |
| value idex | sources published values of used vehicles, examples: |
| sources | Black Book(tm), Kelly's Blue Book (tm) and the |
| | NADA Guide (tm) |
| idex databases | published values of used vehicles, examples - |
| | see index sources |
| hierarchical | vehicle classifications including extra clean, clean, |
| vehicle | average or rough |
| condition | |
| classifications | |

Abbreviations Table

| | |
|---|---|
| Admin | Administrator |
| addr | address - typically an IP address |
| API | application program interface |
| ASP | application service provider - server on a network |
| bd | board |
| CD-RW | compact disk drive with read/write feature for CD disk |
| comm. | communications, typically telecommunications |
| CPU | central processing unit |
| db | database |
| Disp | display, typically display a web page or display certain |
| | information |
| doc | document |
| dr | drive, e.g., computer hard drive |
| DS | data storage |
| e | encryption |
| Equip | equipment |
| est | estimate |
| ext-data | extracted data |
| I/O | input/output |
| id | identify |
| loc | location |
| mem | memory |
| T-Mess | message as in SMS or text message |
| obj | object, for example, a data object |
| opt | optional |
| pgm | program |
| P/W | password |
| Rcd | database record or record profile |
| re | regarding or relating to |
| rel | release |
| RQT | request |
| rev | review |
| Rpt | Report |
| rt | real time, may include day and time stamp data |
| Sel | select |
| Svr | sever, as in web server |
| sys | system |
| Sys Op | System Operator |
| t | time |
| telecom | telecommunications system or network |
| UPP | user personal profile (may be individual or business) |
| URL | Uniform Resource Locator, x pointer, or other network |
| | locator |
| w/ | with |
| w/in | within |
| w/out | without |
| wrt | with respect to |

FIG. 2 diagrammatically illustrates the distributed computer system within which operates the method and the processes described herein. The global telecommunications system or internet 10 enables communication and data transport between a plurality of relatively independent computer systems. The typical computer system 12 includes display monitor 22, input device or keypad 24, input pointer device or mouse 26, and processor unit 28. Manual input can be made via various computers in FIG. 2 or via telephone call center 42. Web-based input of data is also used. Processor unit 28 includes a central processing unit or CPU 30, memory 32 and an input/output or I/O device 34. The I/O is coupled to the internet 10. It should be appreciated that memory 32 represents many types of data storage including hard drives, volatile and non-volatile memory, and removable drives. Also, I/O 34 represents a plurality of input/output devices which are utilized to couple items which are peripheral to processing unit 28. I/O 34 is connected to internet 10. The computer employing the method may be a laptop computer 17 or Internet-enabled tablet (not shown) which can easily be connected to internet for cloud-based processing and cloud storage. Other computers 14 and 16 are also coupled together via the internet. An administrative computer(s) 18, 20 which assists in the overall control and operation of the system and the method described herein. User Computers 12, 14, 16, 17 are client computer systems operated by vendors, merchants, data suppliers, and customers who seek activate the processes discussed herein to purchase the contract services via the internet.

In a preferred embodiment, the system and method is deployed on internet 10 via computer system server 20 and specific control is provided by Admin computer 18. For example, the company or entity, sometimes referred to herein and in the drawings as Sys Oper, providing the options contract or the vehicle owner—second party contract employs Admin computer 18 to establish the method and system. Once operational, live agents at telecomm center 42 may collect data from various vehicle owners regarding an accident claim. The data for the accident claim (to recover the diminished value of the vehicle) is stored in the server 20. If agents of the Sys Oper are in the field, such as at computer 16, the Sys Oper agents enter data for the accident claim. The Server 20 includes CPU 36, memory 38 and I/O 40, and is coupled to Internet 10. The server 20 processes the data as set forth above. For example, the server is automatically programmed to gather index data in real time about the $index. The server would connect to the Black Book Computer, such as vendor computer 16. The Sys Oper agents enter data, for example via computer 16, regarding the third party offer $ACO to buy the damaged vehicle.

In a preferred embodiment, inquiries regarding the overall contract, prior to the accident, are obtained by utilizing a web browser or other type of interface on a user computer(s) (a client computer) to activate and download web-based pages from server 20, all under the supervision and control of admin computer 18. After the accident, web-based data collection processes are used. For example, the proposed contract for diminished value has certain pre-set values such as $Min coverage and $Max coverage. The $Min coverage and $Max coverage may be selected by the vehicle owner from a pull down menu, thereby enabling the owner to select more or less coverage for diminished value. Also, in a highly automated system, the owner completes a UPP and this data is stored on Server 20. The information obtained by user computer(s) is generally stored in server 20.

After the accident, the information is input by the owner or by the Sys Oper agent via computers 14, 16 etc. The server 20 obtains the $index ($I or $Blk-D) and processes the claim as described above. The data is processed by server 20 and the output information representing processed data is delivered to the user via Internet and ultimately to user or user client computer(s). The “user” may be the owner of the Sys Oper agent or the Sys Oper itself.

In the event audio information from users is obtained for the processes in the system, then users call into telecommunications center 42 via phone system 46. Computer system 44 processes the audio into digital format and the resulting data is further processed by the server 20 under the primary control of admin computer 18.

Discussion of Hardware and Software Implementation Options

The present invention could be produced in hardware or software, or in a combination of hardware and software, and these implementations would be known to one of ordinary skill in the art. The system, or method, according to the inventive principles as disclosed in connection with the preferred embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as a local area network (LAN) or widely distributed network (WAN) over a telecommunications system (such as the Internet) as would be known to a person of ordinary skill in the art.

According to the inventive principles as disclosed in connection with the preferred embodiments, the invention and the inventive principles are not limited to any particular kind of computer system but may be used with any general purpose computer, as would be known to a person of ordinary skill in the art, arranged to perform the functions described and the method steps described herein. The operations of such a computer, as described above, may be according to a computer program contained on a medium for use in the operation or control of the computer, as would be known to person of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM or other optical memory storage devices, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

The claims appended hereto are meant to cover modifications and changes within the scope of the invention.

What is claimed is:

1. A computer assisted method providing an option contract for a vehicle owner to recover diminished value of the owner's vehicle subject to accidental damage from a second party holding the option contract comprising:
all subsequent to the accidental damage:
obtaining an estimate to repair the damaged vehicle;
obtaining a bonafide offer to buy the damaged vehicle from a third party buyer;
determining whether the owner reported the accidental damage event;
via a computer coupled to the internet:
obtaining an index value for the damaged vehicle from one or more sources which estimate the value of used vehicles, from the group of indexes including the Black Book™, Kelly's Blue Book™ and the NADA Guide™ for used cars, and selecting either (a) the lowest index value for the damaged vehicle from vehicle classifications including extra clean, clean, average or rough, or (b) a composite average of two or more indexes including the Black Book™, Kelly's Blue Book™ and the NADA Guide™ for used cars, and selecting the lowest index value for the damaged vehicle from vehicle classifications including extra clean, clean, average or rough;
loading said estimate to repair the damaged vehicle into the computer as $repair;
loading said bonafide offer to buy the damaged vehicle into the computer as $ACO;
loading an event-report into the computer based upon whether the owner reported the accidental damage event and if NOT, then assigning a no-report-code to the event, and if YES, assigning a report-code to the event;
referring to said index value for the damaged vehicle as $index;
pre-selecting, prior to the accidental damage (a) a maximum coverage to reimburse the vehicle owner for the diminished value of the owner's vehicle subject to accidental damage which is referred to as $max-coverage and (b) a minimum coverage amount payable under certain circumstances which is referred to as $min-coverage;
for a no-report-coded accident event, calculating a pay-out to the owner as either: (a) if $ACO is greater than $index, then offer the owner nothing, and (b) if $ACO is less than $index, then offer the owner $ACO plus $min-coverage for the diminished value of the vehicle;
for a report-coded accident event, calculating a pay-out to the owner as one of: (a) if $repair is less than $max-coverage, and $repair is less than $index minus $ACO, then offer the owner $repair for the diminished value of the vehicle; (b) if $repair is less than $max-coverage, and $repair is greater than $index minus $ACO, then offer the owner $index minus $ACO but reduce offer to no more than the $max-coverage for the diminished value of the vehicle; (c) if $repair is greater than $max-coverage, and $max-coverage is less than $index minus $ACO, then offer the owner $max-coverage for the diminished value of the vehicle; and (d) if $repair is greater than $max-coverage, and $max-coverage is greater than $index minus $ACO, then offer the owner $index minus $ACO for the diminished value of the vehicle;
effecting payment to the owner for the damaged vehicle in accordance with the computer generated payment if and when the owner transfers ownership of the damaged vehicle to the second party.

2. A computer assisted method providing an option contract for vehicle owners as claimed in claim 1 wherein the $min-coverage is $0.

3. A computer assisted method providing an option contract for vehicle owners as claimed in claim 1 wherein for the no-report-coded accident event, calculating the pay-out to the owner as either: (a) if $ACO is greater than $index, then offer the owner nothing, and (b) if $ACO is less than or equal to $index, then offer the owner $ACO plus $min-coverage for the diminished value of the vehicle.

4. A computer assisted method providing an option contract for vehicle owners as claimed in claim 1 wherein
for the report-coded accident event, calculating the pay-out to the owner as one of: (a) if $repair is less than or equal to $max-coverage, and $repair is less than or equal to $index minus $ACO, then offer the owner $repair for the diminished value of the vehicle; (b) if $repair is less than or equal to $max-coverage, and $repair is greater than or equal to $index minus $ACO, then offer the owner $index minus $ACO but reduce offer to no more than the $max-coverage for the diminished value of the vehicle; (c) if $repair is greater than or equal to $max-coverage, and $max-coverage is less than or equal to $index minus $ACO, then offer the owner $max-coverage for the diminished value of the vehicle; and (d) if $repair is greater than or equal to $max-coverage, and $max-coverage is greater than or equal to $index minus $ACO, then offer the owner $index minus $ACO for the diminished value of the vehicle.

5. A computer assisted method for contractually permitting a vehicle owner to recover diminished value of the owner's vehicle subject to accidental damage from a second contracting party comprising:
after the accidental damage:
obtaining an estimate to repair the damaged vehicle;
obtaining a bonafide offer to buy the damaged vehicle from a third party buyer;
determining whether the owner reported the accidental damage event;
computing an amount payable to the owner via a computer:
obtaining a present index value for the damaged vehicle from one or more database sources which publish values of used vehicles and selecting, as the index value, the lowest index value for the damaged vehicle from a group of hierarchical vehicle condition classifications, said index value for the damaged vehicle being $index;
obtaining said estimate to repair the damaged vehicle as $repair;
obtaining said bonafide offer to buy the damaged vehicle as $ACO;
inputting an event-report into the computer based upon whether the owner reported the accidental damage event and if NOT, then assigning a no-report-code to the event, and if YES, assigning a report-code to the event;
obtaining prior to the accidental damage a maximum contractual coverage as $max-coverage;
obtaining prior to the accidental damage a minimum coverage contractual coverage as $min-coverage;
processing a first payment offer for a no-report-coded accident event as either: (a) if $ACO is greater than $index, then offer $0; and (b) if $ACO is less than $index, then offer $ACO plus $min-coverage;
processing a second payment offer for a report-coded accident event, as one of: (a) if $repair is less than $max-coverage, and $repair is less than $index minus $ACO, then offer $repair; (b) if $repair is less than $max-coverage, and $repair is greater than $index minus $ACO, then offer$index minus $ACO but no more than the $max-coverage; (c) if $repair is greater than $max-coverage, and $max-coverage is less than $index minus $ACO, then offer $max-coverage; and
(d) if $repair is greater than $max-coverage, and $max-coverage is greater than $index minus $ACO, then offer$index minus $ACO;
closing the contract by effecting payment to the owner as the processed payment offer when the owner transfers ownership of the damaged vehicle to the second contracting party.

6. A computer assisted method for contractually permitting a vehicle owner to recover diminished value of the owner's vehicle as claimed in claim 5 wherein:
processing the first payment offer for a no-report-coded accident event as either: (a) if $ACO is greater than $index, then offer $0; and (b) if $ACO is less than or equal to $index, then offer $ACO plus $min-coverage.

7. A computer assisted method for contractually permitting a vehicle owner to recover diminished value of the owner's vehicle as claimed in claim 5 wherein:
the processing of the second payment offer for the report-coded accident event as one of: (a) if $repair is less than or equal to $max-coverage, and $repair is less than or equal to $index minus $ACO, then offer $repair; (b) if $repair is less than or equal to $max-coverage, and $repair is greater than or equal to $index minus $ACO, then offer$index minus $ACO but no more than the $max-coverage; (c) if $repair is greater than or equal to $max-coverage, and $max-coverage is less than or equal to $index minus $ACO, then offer $max-coverage; and (d) if $repair is greater than or equal to $max-coverage, and $max-coverage is greater than or equal to $index minus $ACO, then offer$index minus $ACO.
